(19) United States
(12) Patent Application Publication
(10) Pub. No.: US 2026/0004171 A1
(43) Pub. Date: Jan. 1, 2026

(54) CHARGED PARTICLE TRAP OPERATION

(71) Applicant: OXFORD IONICS LIMITED, Begbroke (GB)

(72) Inventors: Raghavendra SRINIVAS, Begbroke (GB); David ALLCOCK, Begbroke (GB); Maciej MALINOWSKI, Begbroke (GB); Chris BALLANCE, Begbroke (GB)

(21) Appl. No.: 18/880,758

(22) PCT Filed: Jul. 4, 2023
(86) PCT No.: PCT/GB2023/051752

§ 371 Date: Jan. 2, 2025

(30) Foreign Application Priority Data
Jul. 4, 2022 (GB) 2209813.1

(51) Int. Cl. G06N 10/20; H01J 49/42

(52) U.S. Cl. CPC G06N 10/20; H01J 49/4255

(57) ABSTRACT

A method of operating a charged particle trap which includes a set of trap electrodes. The method comprise trapping a first charged particle at a first position, the first charged particle providing a first qubit having a first transition frequency and trapping a second charged particle, at a second position, the second charged particle providing a second qubit having a second transition frequency. The method comprises applying a potential gradient to the first and second charged particles, wherein the first and second charged particles experience first and second magnitudes of potential gradient, respectively, and wherein the potential gradient oscillates at a given frequency and is monochromatic. The method comprises, while applying the potential gradient, applying a first oscillating potential to a first electrode at a first given frequency so as to apply a first oscillating electric field to the first charged particle and applying a second oscillating potential to a second electrode at a second frequency so as to apply a second oscillating electric field to the second charged particle.

### FIELD

The present invention relates to operating a charged particle trap.

### BACKGROUND

A quantum computing architecture requires the ability to control individual qubits. Typically, this is achieved using spatially-varying control fields whereby each qubit experiences a different, locally-adjustable coupling.

In trapped-ion architectures, two approaches are mainly used, namely focused laser beams and spatially-varying magnetic fields. Generating highly-controlled, localised laser or magnetic fields, at scale, is, however, challenging. Consequently, a common approach that is used to address single-qubit operations is to employ imperfectly localised fields and to manipulate ions, i.e., to move ions in and out of regions to which the fields are applied. In this so-called “shuttling-based” approach, a single-qubit operation consists of ion shuttling and applying laser or magnetic pulses.

These approaches can have one or more drawbacks. For example, ion shuttling is slow due to the need to filter control electrodes, and this causes a bottleneck for performing single-qubit operations. Furthermore, simply shuttling ions within a field generated by a single source does not allow for individual phase control. Thus, to operate efficiently on N qubits in parallel, O(N) individually adjustable laser or magnetic field sources are usually needed. Integrating these sources into an ion-trap system is challenging and resource-intensive.

R. T. Sutherland, R. Srinivas, and D. T. C. Allcock, “Individual addressing of trapped ion qubits with geometric phase gates”, (14 Jun. 2022) available from https://arxiv. org/pdf/2206.06546.pdf describes a scheme for individual addressing of trapped ion qubits, selecting them via their motional frequency. In this scheme, one ion acts as a “target” qubit and another ion acts as “spectator” qubit. Both qubits are driven with a pair of bichromatic microwave fields and an rf B-field gradient, thereby resulting in a potential gradient which is trichromatic.

### SUMMARY

According to a first aspect of the present invention there is provided a method of operating a charged particle trap which includes a set of trap electrodes. The method comprises trapping a first charged particle at a first position, the first charged particle providing a first qubit having a first transition frequency, and trapping a second charged particle at a second position, the second charged particle having a second transition frequency.

The method comprises applying a potential gradient to the first and second charged particles wherein the first and second charged particles experience first and second magnitudes of potential gradient, respectively, and the potential gradient oscillates at a given frequency and is substantially monochromatic. The method comprises, while applying the potential gradient, applying a first oscillating potential to a first electrode at a first frequency so as to apply a first oscillating electric field to the first charged particle, and applying a second oscillating potential to a second electrode at a second frequency so as to apply a second oscillating electric field to the second charged particle.

The first oscillating electric field is preferably applied locally to the first charged particle and the second oscillating electric field is preferably applied locally to the second charged particle.

The first and second transition frequencies may be different. The first and second frequencies (of the oscillating potentials) may be different.

The potential gradient may be applied for a longer period than the first and second oscillating potentials, or vice versa.

The first oscillating electric field may have a first phase value and the second oscillating electric field may have a second, different phase value. The phase of the quantum gate (i.e., rotation axis on the Bloch sphere) can be adjusted by changing the phase of the oscillating electric field relative to the phase of the potential gradient.

Applying the potential gradient may comprise applying at least one magnetic field gradient and/or laser field(s) to the first and second charged particles.

The method may further comprise applying a carrier drive to the first and second charged particles.

Applying the potential gradient to the first and second charged particles may comprise driving an oscillating current through an elongate conductive element for generating the at least one magnetic field.

The elongate conductive element may include first and second sections, wherein the first and second sections of the elongate conductive element are non-collinear. The elongate conductive element may comprise driving a first oscillating current through a first elongate conductive element, and driving a second oscillating current through a second elongate conductive element spaced apart from the first elongate conductive element.

The charged particle trap may include a substrate having a principal surface.

At least a first set of the set of trap electrodes, or all of the trap electrodes, may be disposed on the principal surface of the substrate or other surface. A second set of the set of trap electrodes may be supported on a different surface and are non-coplanar with the first set. The charged particle trap may include at least one elongate conductive element, which may be disposed on the principal surface of the substrate or other surface, for generating the at least one magnetic field.

The least one elongate conductive element may be disposed on the principal surface of the substrate. The least one elongate conductive element may be disposed on another surface of the substrate. The least one elongate conductive element may be disposed on a different substrate.

The set of set of trap electrodes may include first and second arrays of trap electrodes and the at least one elongate conductive element may be interposed between the first and second arrays of trap electrodes.

The first array of trap electrodes may comprise first trap electrodes spaced apart along a first direction, the second array of trap electrodes may comprise second trap electrodes spaced apart along the first direction, and the first and second arrays of trap electrodes are preferably spaced apart in a second direction orthogonal to the first direction.

The one elongate conductive element may be supported on a different surface and may be non-coplanar with the first set of trap electrodes.

Applying the potential gradient to the first and second charged particles may comprise illuminating the first and second charged particles with at least one laser beam.

The first charged particle may have a given mode of oscillation having a given direction of oscillation and the method may comprise applying the potential gradient such that the potential gradient at the first charged particle has a component which is not perpendicular to the given direction of oscillation and the potential gradient at the second charged particle has a component which is not perpendicular to the given direction of oscillation, applying the first oscillating electric field such that that first oscillating electric field is not perpendicular to the given direction of oscillation, and applying the second oscillating electric field such that that second oscillating electric field is not perpendicular to the given direction of oscillation.

The set of trap electrodes may include the first and second electrodes. In other words, trap electrode may be used to provide the local oscillating electric fields.

The method may comprise trapping a third charged particle at a third position, the third charged particle providing a third qubit having a third transition frequency and applying the potential gradient to the third charged particle, wherein the third charged particle experiences a third magnitude of potential gradient. The method may comprise, while applying the potential gradient, applying a third oscillating potential to a third electrode at a third frequency so as to apply a third oscillating electric field to the third charged particle.

The method may comprise trapping N charged particles, each charged particle trapped at a respective position, each charged particle providing a respective qubit having a respective transition frequency. The method may comprise applying the potential gradient to the N charged particles, wherein the charged particle experiences a respective magnitude of potential gradient. The method may comprise, while applying the potential gradient, applying respective oscillating potentials to respective electrodes at respective frequencies so as to apply a respective oscillating electric field to a respective charged particle.

There may be between 10 and 1000 charged particles.

A charged particle may be an ion, such as calcium ion, atom or molecule with a net electric charge, an electron or a positron. The charged particles may include different charged particles, e.g., different ions.

According to a second aspect of the present invention there is provided a system comprising a charged particle trap which includes a set of trap electrodes and a control system for controlling the charged particle trap. The control system is configured to trap a first charged particle at a first position, the first charged particle providing a first qubit having a first transition frequency, to trap a second charged particle at a second position, the second charged particle having a second transition frequency, to apply potential gradient to the first and second charged particles, wherein the first and second charged particles experience first and second magnitudes of potential gradient, respectively, and wherein the potential gradient oscillates at a given frequency. The control system is configured, while applying the potential gradient, to apply a first oscillating potential to a first electrode at a first frequency so as to apply a first oscillating electric field to the first charged particle, and to apply a second oscillating potential to a second electrode at a second frequency so as to apply a second oscillating electric field to the second charged particle.

### BRIEF DESCRIPTION OF THE DRAWINGS

Certain embodiments of the present invention will now be described, by way of example, with reference to the accompanying drawings, in which:

FIG. 1 is a schematic view of ions trapped in an ion trap each providing a respective qubit;

FIG. 2 is a schematic block diagram of a system for independently controlling qubits shown in FIG. 1;

FIG. 3 is a process flow diagram of a method of operating a multi-qubit trapped-ion gate including a set of trap electrodes.

FIG. 4 is a schematic perspective view of a first trapped-ion gate;

FIG. 5 is a schematic plan view of the first trapped-ion gate shown in FIG. 4;

FIG. 6 is a schematic circuit arrangement for combining DC and AC signals;

FIG. 7 is a schematic perspective view of a second trapped-ion gate; and

FIG. 8 is a schematic plan view of the second trapped-ion gate shown in FIG. 7.

### DETAILED DESCRIPTION OF CERTAIN EMBODIMENTS

### Introduction

In the following, methods of performing parallel, single-qubit control, which do not require the use of individually adjustable laser or magnetic field sources, are described.

The methods do not require localised laser or magnetic fields, or for ions to be moved in and out of localised regions for processing (i.e., regions to which a localised laser or magnetic field is applied), thereby ameliorating speed bottleneck issues associated with ion shuttling. Instead, a global potential gradient (e.g., generated using one or more currents flowing through one or more elongate conductors, such as a wire or track) can be used in combination with localised oscillating electric fields, preferably low-frequency (e.g., 0.1 to 20 MHz). Such electric fields may be easier to localise and to apply compared to laser or magnetic fields. Furthermore, local control can employ existing trap structures (e.g., surface-electrode ion trap electrodes) rather than provide additional dedicated laser or magnetic field sources. The methods are parallelisable, and local control can be achieved by adjusting amplitude and phase of a local electric field. In other words, single-qubit rotation phase can be controlled via a locally adjustable electric field phase.

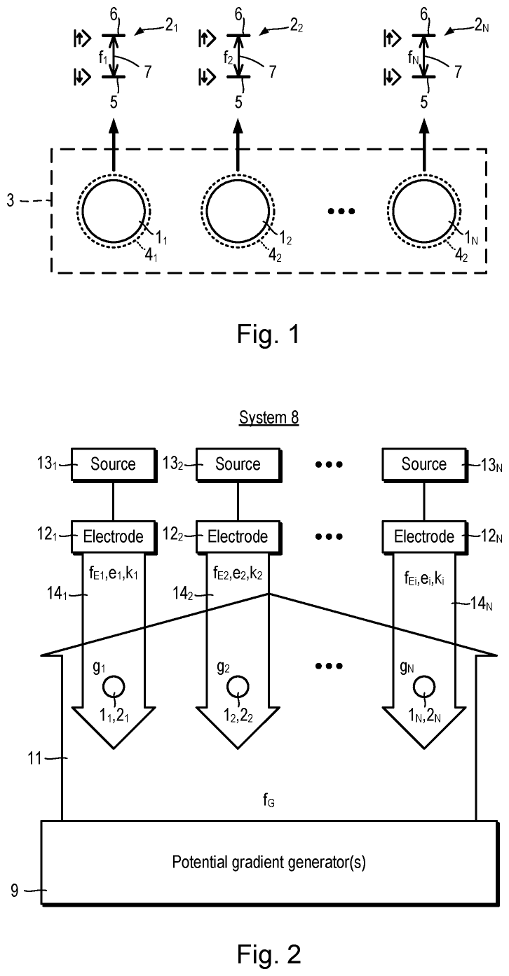

Referring to FIG. 1, a plurality of charged particles 1₁, 1₂, . . . , 1_{N} are shown.

In this case, the charged particles 1₁, 1₂, . . . , 1_{N} are ions. A charged particle may, however, take the form of an atom or molecule with a net electric charge, an electron or positron. There may be three or more charged particles 1₁, 1₂, . . . , IN. For example, there may be between 10 and 1000 charged particles 1₁, 1₂, . . . , 1_{N}, i.e., 10≤N≤1000. There may be more than 1000 charged particles.

Each ion 1₁, 1₂, . . . , 1_{N} provides a respective qubit 2₁, 2₂, . . . , 2_{N} and is spatially confined in an ion trap 3 at respective positions 4₁, 4₂, . . . , 4_{N}. Each qubit 2₁, 2₂, . . . , 2_{N} has two states 5, 6, and a transition 7 between the two states 5, 6. Each qubit 2₁, 2₂, . . . , 2 has a respective transition frequency f₁, f₂, . . . , f_{N}.

Referring also to FIG. 2, individual qubits 2₁, 2₂, . . . , 2_{N} can be independently controlled using a system 8.

The system 8 includes potential gradient generator(s) 9 for generating a potential gradient 11. The potential gradient generator(s) 9 may take the form of one or more magnetic field gradient sources and/or laser field sources which generates (generate) an oscillating magnetic field gradient or a laser field 11 having a frequency of oscillation f_{G} which can be applied globally to the ions 1₁, 1₂, . . . , 1_{N}. One or more generators 9 may be used to generate the potential gradient 11, although the number of generators 9 is less than the number of ions 1₁, 1₂, . . . , 1_{N}.

Each ion 1₁, 1₂, . . . , 1_{N} experiences a potential gradient 11 of respective magnitude g₁, g₂, . . . g_{N}. The potential gradient may be in any direction.

The ions 1₁, 1₂, . . . , 1_{N} experience a monochromatic (or “single tone”) potential gradient 11. Thus, if a single potential gradient generator 9 is used, then it is arranged to generate a monochromatic potential gradient 11 and so the ions 1₁, 1₂, . . . , 1_{N} see a monochromatic potential gradient 11. If, however, more than one potential gradient generator 9 is used, the potential gradient generators 9 are arranged to produce a net potential gradient 11 which is monochromatic as seen by the ions 1₁, 1₂, . . . , 1_{N}.

A monochromatic gradient can have one or more benefits, such as making implementation easier and helping to lower resulting operation errors. For example, delivering a single frequency allows for simple single-point impedance matching.

The system 8 also includes a plurality of electrodes 12₁, 12₂, . . . , 12_{N} and signal sources 13₁, 13₂, . . . , 13_{N} which generate oscillating electric fields 14₁, 14₂, . . . , 14_{N}, which are applied locally to respective ions 1₁, 1₂, . . . , 1_{N}. The electrodes 12₁, 12₂, . . . , 12_{N} may be the same as at least some of the electrodes used to trap the ions 1₁, 1₂, . . . , 1_{N}.

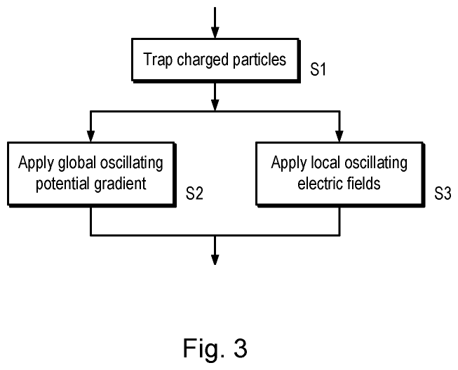

Referring also to FIG. 3, in a method of single-qubit operation, the trapped-ion qubits 2₁, 2₂, . . . , 2_{N} are confined in the ion trap 3 (step S1).

The potential gradient generator(s) 9 is (are) switched on, for a period of time ti (step S2). Each ion 1₁, 1₂, . . . , 1_{N} experiences a respective potential gradient having a magnitude g₁, g₂, . . . , g_{N}. The magnitude of the potential gradient 11 oscillates at the frequency f_{G}. The potential gradient 11 is monochromatic.

At the same time, the signal sources 13₁, 13₂, . . . , 13_{N} apply oscillating signals to the electrodes 12₁, 12₂, . . . , 12_{N} (step S3). Each ion 1₁, 1₂, . . . , 1_{N} experiences a respective electric field 14₁, 14₂, . . . , 14_{N} having a respective frequency, f_{Ei}, amplitude eᵢ and phase kᵢ (where i=1, 2, . . . , N). These parameters are adjustable locally. Adjusting phase kᵢ locally enables parallel operations to be performed.

The potential gradient 11 and the electric field 14₁, 14₂, . . . , 14_{N} are applied simultaneously for a period of time ti. At the end of this time period, one or more of the qubits 2₁, 2₂, . . . , 2_{N} may have undergone an addressed operation.

Examples of systems which employ a globally-applied potential gradient and locally-applied electric fields will now be described.

### System Using Current-Generated Magnetic Field Gradient

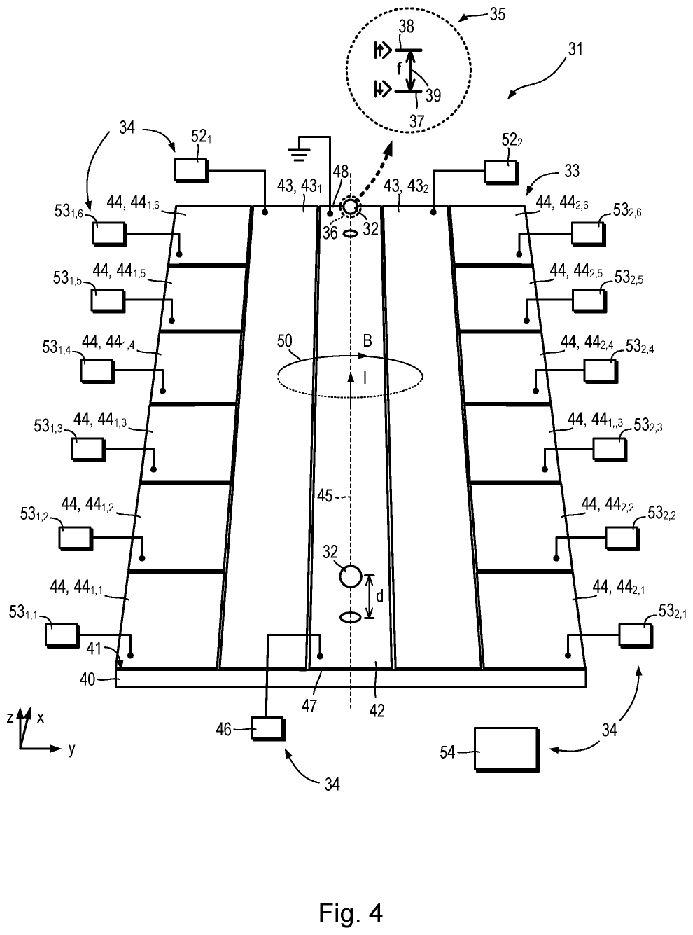

Rereferring to FIG. 4, a first system 31 for quantum information processing using trapped charged particles 32 is shown.

The system 31 includes a charged particle trap 33 that may be housed in a vacuum chamber (not shown), which provides an ultrahigh vacuum environment allowing individual charged particles to be isolated, and a control system 34 for the trap 33.

In this case, charged particles 32 take the form of ions, such as calcium ions (⁴⁰Ca⁺). For brevity, charged particles are also herein referred to as “ions”. The charged particles may, however, take the form of atoms or molecules with net electric charge, or elementary charged particles, such as electrons or positrons.

As hereinbefore described, each ion 32 provides a respective qubit 35 and can be spatially confined in the trap 33 at respective positions 36. Each qubit has two states 37, 38 and a transition 39 between the two states 37, 38. Each qubit 35 has a respective transition frequency fᵢ which can be measured, for example, using Rabi or Ramsey spectroscopy.

The trap 33 takes the form of surface-electrode trap, and comprises a substrate 40 having an upper surface 41 which supports a plurality of electrodes 42, 43, 44.

The electrodes 42, 43, 44 include central electrode 42 takes the form of a strip running along a longitudinal axis 45, and first and second electrodes 43₁, 43₂ take the form of respective strips running either side along the central electrode 42 such that the central electrode 42 is interposed between the first and second electrodes 43₁, 43₂. AC signals at RF frequencies are applied to the first and second electrodes 43₁, 43₂ (herein also referred to as “first and second RF electrodes”) for producing ponderomotive confining potentials.

The electrodes 42, 43, 44 includes a set of trap electrodes 44_{1,1}, 44_{1,2}, 44_{1,3}, 44_{1,4}, 44_{1,5}, 44_{1,6}, 44_{2,1}, 44_{2,2}, 44_{2,3}, 44_{2,4}, 44_{2,5}, 44_{2,6} arranged in two linear arrays (or “columns” or “rows”) outside the first and second RF electrodes 43₁, 43₂.

Examples of surface-electrode traps can be found in WO 2021/205145 A1 which is incorporated herein by reference.

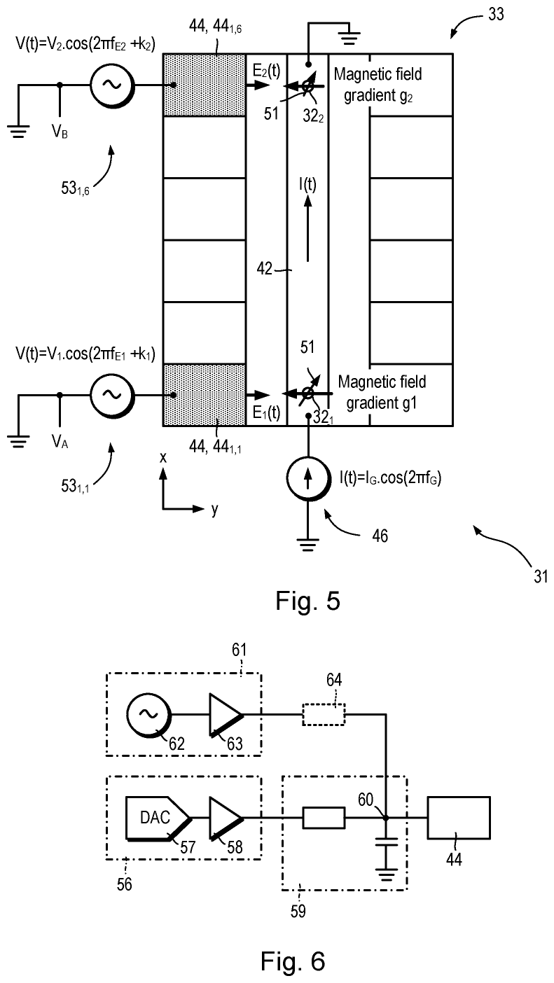

The control system 34 includes a current source 46 for driving an oscillating current I(t) through the central electrode 42 between first and second ends 47, 48. The second end 48 of the central electrode 52 is grounded. As will be explained in more detail, the current source 46 and central electrode 42 is used to generate a magnetic field 50 which oscillates at a frequency f_{G}. The ions experience respective magnitudes of magnetic field gradient 51 (FIG. 5).

The control system 34 includes first and second voltages sources 521, 522 for applying signals to the first and second RF electrodes 43₁, 43₂, respectively, and voltage sources 53_{1,1}, 53_{1,2}, 53_{1,3}, 53_{1,4}, 53_{1,5}, 53_{1,6}, 53_{2,1}, 53_{2,2}, 53_{2,3}, 53_{2,4}, 53_{2,5}, 53_{2,6} for applying respective signals to the trap electrodes 44_{1,1}, 44_{1,2}, 44_{1,3}, 44_{1,4}, 44_{1,5}, 44_{1,6}, 44_{2,1}, 44_{2,2}, 44_{2,3}, 44_{2,4}, 44_{2,5}, 44_{2,6 6}. The sources 50, 52₁, 52₂, 53_{1,1}, 53_{1,2}, 53_{1,3}, 53_{1,4}, 53_{1,5}, 53_{1,6}, 53_{2,1}, 53_{2,2}, 53_{2,3}, 53_{2,4}, 53_{2,5}, 53_{2,6} are controlled by a computer system 54.

Referring also to FIG. 5, operation of the system 31 is described in more detail.

Two trapped ions 32₁, 32₂ can be addressed in parallel in the surface-electrode trap 33.

Both ions 32₁, 32₂ are coupled to one potential gradient source, i.e., central electrode 42. The potential gradient 51 is generated by passing an oscillating current I(t) through the central electrode 45. Local control is achieved by injecting oscillating voltages onto first and second electrodes 44_{1,1}, 44_{1,6}, respectively. The ions 32₁, 32₂ are spaced sufficiently far away from each other such the coupling from the first electrode 44_{1,1} to the second ion 32₂, and from the second electrode 44_{1,6} to the first ion 32₁, are very small.

A trapping electrode 44 may be used not only to apply a DC electric field used in trapping, but also an oscillating electric field. For example, a first source 53_{1,1} may add a first DC offset voltage VA and a first oscillating voltage V(t)=V₁·cos(2πf_{E1}+k₁) and apply a first combined voltage to the first electrode 44_{1,1} and a second source 53_{1,6} may add a second DC offset voltage VB and a second oscillating voltage V(t)=V₂·cos(2πf_{E2}+k₂) apply a first combined voltage to the second electrode 44_{1,6}.

Referring to FIG. 6, a suitable signal generator arrangement 55 is shown.

A DC voltage source 56 may include a digital-to-analogue converter 57 and an amplifier 58. The voltage source 56 is coupled to the electrode 44 via a low-pass RC filter 59 via node 60 between resistor R and capacitor C. An AC voltage source 61 may include an AC source 62 and an amplifier 63, and an optional series filter 64 coupled to the output of the source 61. The output of the source 61 or, if used, filter 64 is connected to the node 60 and, thus, to the electrode.

### System Using Laser-Generated Electric Field Gradient

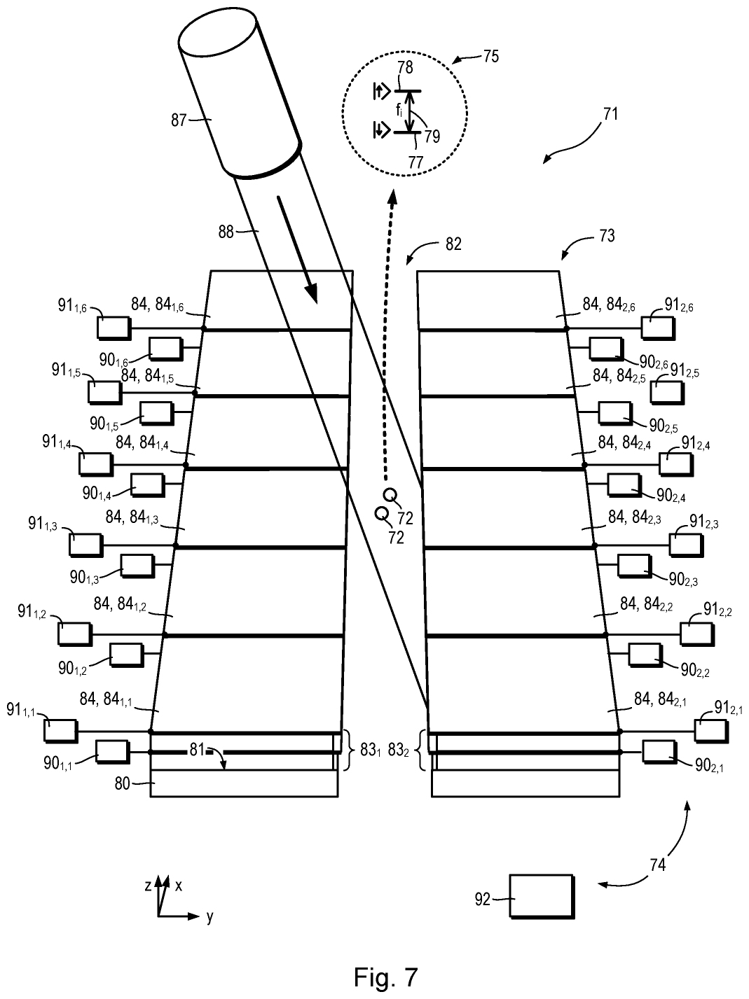

Rereferring to FIG. 7, a second system 71 for quantum information processing using trapped charged particles 72 is shown.

The system 71 includes a charged particle trap 73 that may be housed in vacuum chamber (not shown), which provides an ultrahigh vacuum environment allowing individual charged particles to be isolated, and a control system 74 for the trap 73.

In this case, charged particles 72 take the form of ions, such as calcium ions (⁴⁰Ca⁺). For brevity, charged particles are also herein referred to as “ions”. The charged particles may, however, take the form of atoms or molecules with net electric charge, or elementary charged particles, such as electrons or positrons.

As hereinbefore described, each ion 72 provides a respective qubit 75 and can be spatially confined in the trap 73 at respective positions 76. Each qubit has two states 77, 78 and a transition 79 between the two states 77, 78. Each qubit 75 has a respective transition frequency fᵢ.

The trap 73 takes the form of microfabricated surface-electrode trap, and comprises a substrate 80 having an upper surface 81. The trap 73 comprises an elongate slot 82 through the substrate 80. Either side of the slot 82, the upper surface of the substrate 80 supports an electrode layer stack 83₁, 83₂.

Each electrode stack layer 83₁, 83₂ includes a set of lower electrodes 84₁, 84₂, 84_{1,1}, 84_{2,1} (most lower electrodes are not visible in FIG. 6 or 7), a dielectric layer 85₁, 85₂, and a set of upper electrodes 86₁, 86₂, 86_{1,1}, 86_{1,2}, 86_{1,3}, 86_{1,4}, 86_{1,5}, 86_{2,1}, 86_{2,2}, 86_{2,3}, 86_{2,4}, 86_{2,5}. Each dielectric layer 85₁, 85₂ is interposed between the lower and upper electrodes 84₁, 84₂, 86₁, 86₂.

The control system 74 includes a laser 87 which is used to generate a beam 88 which produces an electric field gradient 89.

The control system 74 includes a first set of voltage sources 90, 90, 90_{1,1}, 90_{1,2}, 90_{1,3}, 90_{1,4}, 90_{1,5}, 90_{2,1}, 90_{2,2}, 90_{2,3}, 90_{2,4}, 90_{2,5} for applying respective signals to the lower electrodes 84, 84_{1,1}, 84_{1,2}, 84_{1,3}, 84_{1,4}, 84_{1,5}, 84_{2,1}, 84_{2,2}, 84_{2,3}, 84_{2,4}, 84_{2,5}, and a second set of voltage sources 91, 91_{1,1}, 91_{1,2}, 91_{1,3}, 91_{1,4}, 91_{1,5}, 91_{2,1}, 91_{2,2}, 91_{2,3}, 91_{2,4}, 91_{2,5} for applying respective signals to the upper electrodes 86, 86_{1,1}, 86_{1,2}, 86_{1,3}, 86_{1,4}, 86_{1,5}, 86_{2,1}, 86_{2,2}, 86_{2,3}, 86_{2,4}, 86_{2,5}.

The sources 87, 90, 91 are controlled by a computer system 92.

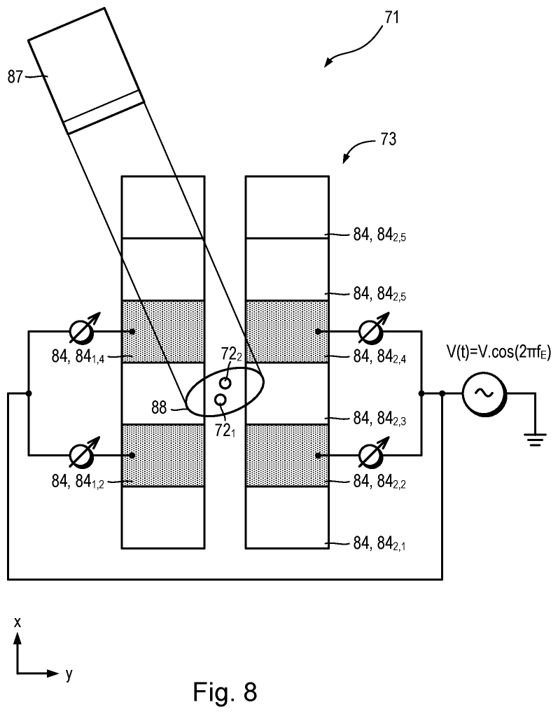

Referring also to FIG. 8, operation of the system 31 is described in more detail

First and second ions 72₁, 72₂ are trapped close to each other in the microfabricated ion trap 73. The ions 72₁, 72₂ are illuminated with a laser beam 88, which serves as a gradient source.

Oscillating electric fields are injected onto opposing pairs of trap electrodes 84_{1,2}, 84_{1,4}, 84_{2,2}, 84_{2,4}. By controlling the phases and amplitudes of the voltages injected to the different electrodes, the electric field at the first ion 72₁ can be nulled, while generating the desired field at the second ion 72₂. This allows a single-qubit rotation to be applied to the right ion, while leaving the left ion unaffected.

### Control Using Frequency, Phase and Amplitude

The methods described herein allow for local, yet parallelisable control in two ways. First, an extent or area of a quantum gate can be locally adjusted by setting amplitude eᵢ and/or time tᵢ. Secondly, a phase of the quantum gate can be locally adjusted by setting phase kᵢ.

The frequency fᵢ of transition for an i^{th} qubit is known (for example, determined by simulation) or can be measured. The frequency f_{G} of oscillation of the gradient field and the frequency f_{Ei} of oscillation for local oscillating field and be adjusted for a desired operation with desired speed.

Calculations and experimental data indicate that, with other parameters fixed, the single-qubit coupling rate is proportional to 1/(f_{Mi}²−f_{Ei}²), where f_{Mi} is motional frequency of ion i. Thus, setting f_{Ei} close to f_{Mi} increases efficiency of coupling, thus, increases speed of operation.

The methods allow implementation of both “spin-flip” and “phase-flip” quantum operations. The choice of operation depends on the choice of frequency fa of oscillation of gradient field and the frequency f_{Ei} of oscillation of the electric field. For example, “spin-flip” operations can be executed by setting f_{Ei}=fᵢ+f_{G} (examples of values are fᵢ=300 MHz, f_{G}=6 MHz, f_{Ei}=306 MHz) and “phase-flip” quantum operations can be executed by settings f_{Ei}=f_{G}.

### Resonances

Operations can be performed using a combination of potential gradient and an oscillating electric field, or a combination of a potential gradient, a carrier drive and an oscillating electric field. A carrier drive can be generated by (a) an electric field generated by one or more laser beams, or (b) a magnetic field. A potential gradient can be generated by (a) by one or more laser beams, or (b) a magnetic field gradient using one or more sources.

First and second methods of performing operations may be performed using a combination of potential gradient and an oscillating electric field. Third and fourth methods of performing operations use a combination of a potential gradient, a carrier drive and an oscillating electric field, and are described herein after.

### First Method-Spin-Flips

A qubit has a transition frequency fᵢ. For an oscillating potential gradient at frequency f_{G} and an oscillating electric field at frequency f_{Ei}, a “spin-flip” operation can be generated using the resonance:

$${f}_{G} = {f}_{i} \pm {f}_{Ei} \qquad ( 1 )$$

The spin flip rate Ω_{spin-flip} is given by:

$${Ω}_{spin - flip} = \frac{{Ω}_{sb} {Ω}_{ε} {ω}_{r}}{( {ω}_{r}^{2} - {ω}_{e}^{2} )} , \qquad ( 2 )$$

where Ω_{sb} is the sideband Rabi frequency (which quantifies the effective potential gradient strength), ωᵣ is the oscillation mode (angular) frequency, ωₑ is the electric-field (angular) frequency, and Ωₑ is given by:

$${Ω}_{ε} = \frac{{qEr}_{0}}{ℏ} , \qquad ( 3 )$$

where q is the charge of the ion, E is the electric field component along the oscillation mode, ℏ is the reduced plank constant, and rₒ is the ion wavepacket size, which can be calculated as:

$${r}_{0} = \sqrt{\frac{ℏ}{2 rn {ω}_{r}}} , \qquad ( 4 )$$

where m is the mass of the ion. As an example, for Ca₄₀⁺ ions, with Ω_{sb}=2 π×1 kHz, ωᵣ=2π×6 MHz, and oscillating E-field of angular frequency ωₑ=2π×5 MHz with magnitude E=10 V/m, Ω_{spin-flip} is calculated to be 2π×35 kHz.

### Second Method-Phase-Flips

A qubit has a transition frequency fᵢ. For an oscillating potential gradient at frequency f_{G} and an oscillating electric field at frequency f_{Ei}, a “phase-flip” operation can be generated using the resonance:

$${f}_{G} = {f}_{Ei} \qquad ( 5 )$$

### Third and Fourth Methods-Spin-Flips

Sometimes, spin-flips are desired, but the first method cannot be used since it relies on using high-frequency potential gradients.

In third and fourth methods, an additional oscillating field, for example in the form of an oscillating magnetic or electric field at frequency f_{Bi} is applied in addition to the gradient an oscillating gradient at frequency f_{G} and an oscillating electric field at frequency f_{Ei}.

The additional carrier drive can be applied in a number of different ways including (a) a magnetic field generated using the same current electrode used to generate the potential gradient, (b) a magnetic field generated using a different electrode, (c) a magnetic field generated using a remote source, such as a microwave horn, (d) a laser field applied from an external laser beam, or I) a laser field applied through a trap-integrated waveguide.

Thus, in the third method, a qubit has a transition frequency fᵢ, then for an oscillating gradient field at frequency f_{G}, an oscillating electric field at frequency f_{Ei}, and an oscillating magnetic or electric field at frequency f_{Ei}, a “spin-flip” can be generated using the resonance:

$${f}_{Bi} - {f}_{i} = m ( {f}_{E} - {f}_{G} ) \qquad ( 6 )$$

where m in an integer. Thus, there are many resonances, each usable for generating spin-flips.

The fourth method is an extension of the second method. Every phase-flip operation corresponds to a shift of the qubit frequency. Thus, once f_{G}=f_{Ei}, the qubit frequency is shifted from fᵢ to fᵢ+d_{f}, where dr is a qubit frequency shift which depends on oscillating electric field frequency f_{Ei}, ion motional mode frequency f_{Mi}, oscillating voltage Vᵢ, oscillating current I_{g}, phase difference kᵢ between the oscillating voltage and current, and trap geometry, and can be measured by qubit spectroscopy.

Once the shift offset d_{f} is calculated and/or measured, a carrier drive can be applied having f_{Ei}=fᵢ+d_{f} to generate a spin-flip. Overall, the resonance condition is:

$${f}_{G} = {f}_{Ei} \qquad ( 7 - 1 )$$

$${f}_{Bi} - {f}_{i} = {d}_{f} \qquad ( 7 - 2 )$$

where d_{f} is the qubit frequency shift caused by applying f_{G}=f_{Ei}.

Changing Amplitude eᵢ, time tᵢ and phase kᵢ

The following may help to understand the effect of adjusting the amplitude eᵢ, duration tᵢ and phase kᵢ of the locally-applied electric fields 14₁, 14₂, . . . 14_{N} (FIG. 2) in the first and second method hereinbefore described.

Reference is made to H. Haffner, C. Roos and R. Blatt “Quantum computing with trapped ions”: https://arxiv.org/pdf/0809.4368.pdf (2008).

Operations can be considered in terms of single-qubit quantum gates corresponding to rotations on the Bloch sphere. Rotations about the z axis are phase flips and rotations about the other axes (i.e., x- or y-axes) are spin flips.

Spin-flip rotations can be expressed in terms of rotation operator R(θ,ϕ) (see equation 10 in H. Häffner, C. Roos and R. Blatt ibid.). θ controls the rotation angle and can be considered to be the gate area, while ϕ adjusts the rotation axis and can be considered to be the gate phase. Phase-flip rotations can be written as a rotation operator R_{z}(θ).

In the first method, the implemented rotation is R(θ,ϕ). The amplitude e; and duration tᵢ of the respective applied electric fields 14₁, 14₂, . . . , 14_{N} can be changed to adjust θ, while phase kᵢ of the respective applied electric fields 14₁, 14₂, . . . , 14_{N} can be changed to adjust ϕ. In the second method, the implemented rotation is Rz(θ). Changing amplitude eᵢ, duration tᵢ and phase kᵢ adjusts θ.

### Additional Comments

The methods hereinbefore described are most efficient when the electric field oscillating frequency f_{Ei} is near-resonant with a motional frequency f_{Mi} of the ion(s) to which the field is applied. Operation is possible for any the electric field oscillating frequency f_{Ei}, but operation speed scales as either 1/(f_{Mi}−f_{Ei}) or 1/(f_{Mi}²−f_{Ei}²) depending on the method (resonance) in question.

The methods hereinbefore describe can have another advantage over those that involve ion transport in that the voltages Vᵢ can be made very low by tuning f_{Ei} near f_{Mi}.

### Modifications

It will be appreciated that various modifications may be made to the embodiments hereinbefore described. Such modifications may involve equivalent and other features which are already known in the design, manufacture and use of trapped-ion gates and component parts thereof and which may be used instead of or in addition to features already described herein. Features of one embodiment may be replaced or supplemented by features of another embodiment.

Although claims have been formulated in this application to particular combinations of features, it should be understood that the scope of the disclosure of the present invention also includes any novel features or any novel combination of features disclosed herein either explicitly or implicitly or any generalization thereof, whether or not it relates to the same invention as presently claimed in any claim and whether or not it mitigates any or all of the same technical problems as does the present invention.

The applicants hereby give notice that new claims may be formulated to such features and/or combinations of such features during the prosecution of the present application or of any further application derived therefrom.

1. A method of operating a charged particle trap which includes a set of trap electrodes, the method comprising:
trapping a first charged particle at a first position, the first charged particle providing a first qubit having a first transition frequency;
trapping a second charged particle at a second position, the second charged particle having a second transition frequency;
applying a potential gradient to the first and second charged particles wherein the first and second charged particles experience first and second magnitudes of potential gradient, respectively, and wherein the potential gradient oscillates at a given frequency and is monochromatic;
while applying the potential gradient:
applying a first oscillating potential to a first electrode at a first frequency so as to apply a first oscillating electric field to the first charged particle; and
applying a second oscillating potential to a second electrode at a second frequency so as to apply a second oscillating electric field to the second charged particle.

2. The method of claim 1, further comprising:
the first oscillating electric field has a first phase value; and/or
the second oscillating electric field has a second, different phase value.

3. The method of claim 1, wherein applying the potential gradient comprises:
applying at least one magnetic field gradient at the given frequency to the first and second charged particles;
applying a laser field at the given frequency to the first and second charged particles; and/or
applying first and second laser fields to the first and second charged particles, wherein the first and second laser fields have first and second laser frequencies, respectively, and the difference between the first and second laser frequencies is equal to the given frequency.

4. The method of claim 1, further comprising:
applying a carrier drive to the first and second charged particles.

5. The method of claim 3, wherein applying the potential gradient comprises:
driving an oscillating current through an elongate conductive element for generating the at least one magnetic field.

6. The method of claim 5, wherein the elongate conductive element includes first and second sections, wherein the first and second sections of the elongate conductive element are non-collinear.

7. The method of claim 3, wherein the applying the at least one potential gradient to the first and second charged particles comprises:
driving a first oscillating current through a first elongate conductive element; and
driving a second oscillating current through a second elongate conductive element spaced apart from the first elongate conductive element.

8. The method of claim 1, wherein the charged particle trap includes a substrate having a principal surface, wherein at least a first set of the set of trap electrodes are disposed on the principal surface of the substrate

9. The method of claim 8, wherein a second set of the set of trap electrodes are supported on a different surface and are non-coplanar with the first set.

10. The method of claim 8, wherein the charged particle trap includes at least one elongate conductive element for generating the at least one magnetic field.

11. The method of claim 10, wherein the set of set of trap electrodes includes first and second arrays of trap electrodes and the at least one elongate conductive element is interposed between the first and second arrays of trap electrodes.

12. The method of claim 10, wherein the one elongate conductive element is supported on a different surface and is non-coplanar with the first set of trap electrodes.

13. The method of claim 1, wherein applying the potential gradient to the first and second charged particles comprises:
illuminating the first and second charged particles with at least one laser beam.

14. The method of claim 1, wherein the first charged particle has a given mode of oscillation having a given direction of oscillation, the method comprising:
applying the potential gradient such that the potential gradient at the first charged particle has a component which is not perpendicular to the given direction of oscillation and the potential gradient at the second charged particle has a component which is not perpendicular to the given direction of oscillation;
applying the first oscillating electric field such that that first oscillating electric field is not perpendicular to the given direction of oscillation; and
applying the second oscillating electric field such that that second oscillating electric field is not perpendicular to the given direction of oscillation.

15. The method of claim 1, wherein the set of trap electrodes includes the first and second electrodes.

16. A system comprising:
a charged particle trap which includes a set of trap electrodes; and
a control system for controlling the charged particle trap;
the control system configured:
to trap a first charged particle at a first position, the first charged particle providing a first qubit having a first transition frequency;
to trap a second charged particle at a second position, the second charged particle having a second transition frequency;
to apply potential gradient to the first and second charged particles, wherein the first and second charged particles experience first and second magnitudes of potential gradient, respectively, and wherein the potential gradient oscillates at a given frequency and is monochromatic;
while applying the potential gradient:
to apply a first oscillating potential to a first electrode at a first frequency so as to apply a first oscillating electric field to the first charged particle; and
to apply a second oscillating potential to a second electrode at a second frequency so as to apply a second oscillating electric field to the second charged particle.
